(19) United States
(12) Patent Application Publication
(10) Pub. No.: US 2005/0163355 A1
(43) Pub. Date: Jul. 28, 2005

(54) Method and unit for estimating a motion vector of a group of pixels

(76) Inventor: Mark Jozef Willem Mertens, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/503,247

(22) PCT Filed: Jan. 20, 2003
(86) PCT No.: PCT/IB03/00143

(30) Foreign Application Priority Data
Feb. 5, 2002 (EP) 02075492.5

(51) Int. Cl. G06K 9/00

(52) U.S. Cl. 382/128

(57) ABSTRACT

A motion estimation unit (200, 300) for estimating a motion vector of a group of pixels of an input image (104) comprises an occlusion detection unit (206) for calculating an occlusion map (116) which is applicable to the input image (104); an intermediate motion estimation unit (202) for estimating a first motion vector for the group of pixels based on the input image (104) and a preceding image (102) and a second motion vector for the group of pixels based on the input image (104) and a succeeding image (106); and an assignment unit (204) for assigning, based on the occlusion map (116), a final motion vector as the motion vector, with the final motion vector derived from the first motion vector or the second motion vector.

The invention relates to a method of estimating a motion vector of a group of pixels of an input image.

The invention further relates to a motion estimation unit for estimating a motion vector of a group of pixels of an input image.

The invention further relates to an image processing apparatus comprising:
receiving means for receiving a signal representing images to be processed;
such a motion estimation unit; and
a motion compensated image processing unit.

An embodiment of the method of the kind described in the opening paragraph is known from U.S. Pat. No. 6,011,596. This patent describes that in a scene of a foreground object moving in front of background objects it is assumed that the foreground object covers the background. Because of the movement the foreground object is continuously covering and uncovering background. An image representing this scene comprises three types of area: covering area, uncovering area and no-covering area. That means a portion of the image will be covered in a succeeding image, a portion of the image will be uncovered in a succeeding image and the rest will still represent the same object in the succeeding image. In a sequence of three images everything that is visible in the center image should be in either the preceding, the succeeding or both.

In order to produce a set of motion vectors which can be used to define substantially all the motions in an input image, first sets of motion vectors are derived from comparisons with preceding and succeeding images. These sets are then combined to produce the set of vectors for assignment to the input image. Once the set of motion vectors has been derived they are assigned to the input image from where they can be projected to produce a desired output image. The motion vectors are assigned to areas, i.e. groups of pixels, of the image.

The method of the above mentioned patent is relatively complicated and requires relatively much memory. Besides that it is not robust. The decision which motion vector of the two sets should be selected is based on the corresponding match errors of the motion vectors of these sets. Hence the match error of a backward motion vector being calculated by means of a preceding image has to be compared with the match error of a forward motion vector being calculated by means of a succeeding image. Temporarily storage of the match errors is required.

It is an object of the invention to provide a method of the kind described in the opening paragraph which is relatively simple.

The object of the invention is achieved in that the method of estimating a motion vector of a group of pixels of an input image comprises:
an occlusion detection step of calculating an occlusion map which is applicable to the input image, with the occlusion map indicating to which of the following types of area the group of pixels of the input image corresponds: covering area, uncovering area or no-covering area;
a first intermediate motion estimation step of estimating a first motion vector for the group of pixels based on the input image and a preceding image of the input image;
a second intermediate motion estimation step of estimating a second motion vector for the group of pixels based on the input image and a succeeding image of the input image; and
an assignment step of assigning, based on the occlusion map, a final motion vector as the motion vector, with the final motion vector derived from the first motion vector or the second motion vector.
   Preferably the group of pixels corresponds to a block of pixels. An important aspect of the invention is the usage of the occlusion map. The result is that a motion estimation unit, being designed to perform the method according to the invention, is relatively simple. In fact, a standard motion estimation unit can be used to perform the first and second intermediate motion estimation step. With a standard motion estimation unit is meant a motion estimation unit which is being designed to estimate motion vectors based on comparing pixel values of pairs of images. A standard motion estimation unit might be the motion estimation unit which is known from the article “True-Motion Estimation with 3-D Recursive Search Block Matching” by G. de Haan et. al. in IEEE Transactions on circuits and systems for video technology, vol.3, no.5, October 1993, pages 368-379. The motion vector fields being calculated by the standard motion estimation unit, i.e. the intermediate motion vector fields, might comprise erroneous motion vectors caused by covering and/or uncovering. By means of the method according to the invention these intermediate motion vector fields are combined to one final motion vector field. Or in other words the erroneous motion vectors corresponding to covering or uncovering areas are substantially removed. Hence, a motion vector field, being determined by a standard motion estimation unit, is improved by means of a kind of post-processing. An advantage of applying a standard motion estimation unit is the relatively low memory requirement. Typically only pixels of two images are kept in memory, simultaneously.

An advantage of applying an occlusion map is that relatively few memory is required. In the method according to the prior art, match errors are used to control the selection of motion vectors. To store match errors, e.g. sum of absolute differences, relatively much memory is required. The usage of the match errors is a reason why the method according to the prior art is less robust.

It is described above that two intermediate motion-vector fields are calculated first and then these are combined. It should be noticed that only for one of these motion vector fields, motion vectors have to be calculated for all groups of pixels of the image for which a motion vector is required. The other intermediate motion vector field might be incomplete. That means that only motion vectors are calculated for groups of pixels which are located in covering or uncovering areas. By doing this, a reduction of computer resource usage is achieved.

In an embodiment of the method according to the invention the final motion vector is derived from:
the first motion vector if the type of area of the group of pixels corresponds to covering area; and
the second motion vector if the type of area of the group of pixels corresponds to uncovering area.
   If the type of area of the group of pixels corresponds to no-covering area it does not make any difference whether the final motion vector is derived from the first motion vector or the second motion vector. Any selection will do. Derived from means that:
the final motion vector directly corresponds to an intermediate motion vector, i.e. the first motion vector or the second motion vector; or
the length of the final motion vector corresponds to the length of an intermediate motion vector, but the direction is reversed.

In an embodiment of the method according to the invention the occlusion map is calculated on basis of a motion vector field. An approach for calculating an occlusion map on basis of a motion vector field is described in the patent application which is entitled “Problem area location in an image signal” and published under number WO0011863. In that patent application is described that an occlusion map is determined by means of comparing neighboring motion vectors of a motion vector field. It is assumed that if neighboring motion vectors are substantially equal, i.e. if the absolute difference between neighboring motion vectors is below a predetermined threshold, then the groups of pixels to which the motion vectors correspond, are located in a no-covering area. However if one of the motion vectors is substantially larger than a neighboring motion vector, it is assumed that the groups of pixels are located in either a covering area or an uncovering area The direction of the neighboring motion vectors determines which of the two types of area. An advantage of this method of occlusion detection is its robustness. It outperforms the method applied in the prior art, i.e. U.S. Pat. No. 6,011,596, which is based on match errors.

In an embodiment of the method according to the invention in which the occlusion map is calculated on basis of a motion vector field, the motion vector field is related to the input image. An occlusion map based on a motion vector field of the image under consideration is most probably the best occlusion map.

In an embodiment of the method according to the invention in which the occlusion map is calculated on basis of a motion vector field, the motion vector field is related to the preceding image. An advantage of this approach is that it enables a simple design of a motion estimation unit according to the invention.

Modifications of the image processing apparatus and variations thereof may correspond to modifications and variations thereof of the motion estimation unit and of the method described. The image processing apparatus may comprise additional components, e.g. a display device for displaying the processed images. The motion compensated image processing unit might support one or more of the following types of image processing:
Video compression, i.e. encoding or decoding, e.g. according to the MPEG standard.
De-interlacing: Interlacing is the common video broadcast procedure for transmitting the odd or even numbered image lines alternately. De-interlacing attempts to restore the full vertical resolution, i.e. make odd and even lines available simultaneously for each image;
Up-conversion: From a series of original input images a larger series of output images is calculated. Output images are temporally located between two original input images; and
Temporal noise reduction. This can also involve spatial processing, resulting in spatial-temporal noise reduction.

These and other aspects of the motion estimation unit, of the method and of the image processing apparatus according to the invention will become apparent from and will be elucidated with respect to the implementations and embodiments described hereinafter and with reference to the accompanying drawings, wherein:

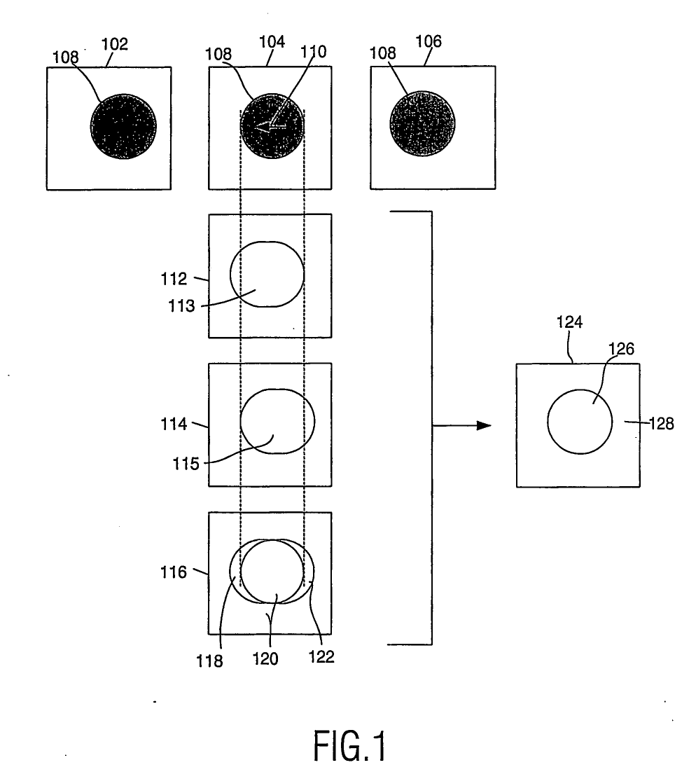

FIG. 1 schematically shows the concept of the method according to the invention;

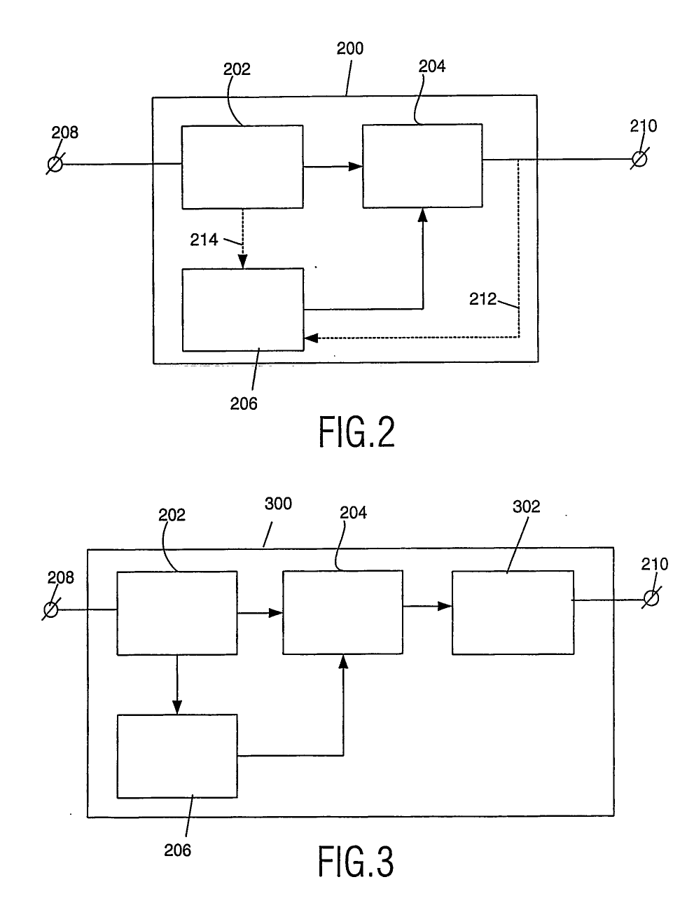

FIG. 2 schematically shows an embodiment of the motion estimation unit;

FIG. 3 schematically shows an embodiment of the motion estimation unit in combination with a re-timer unit; and

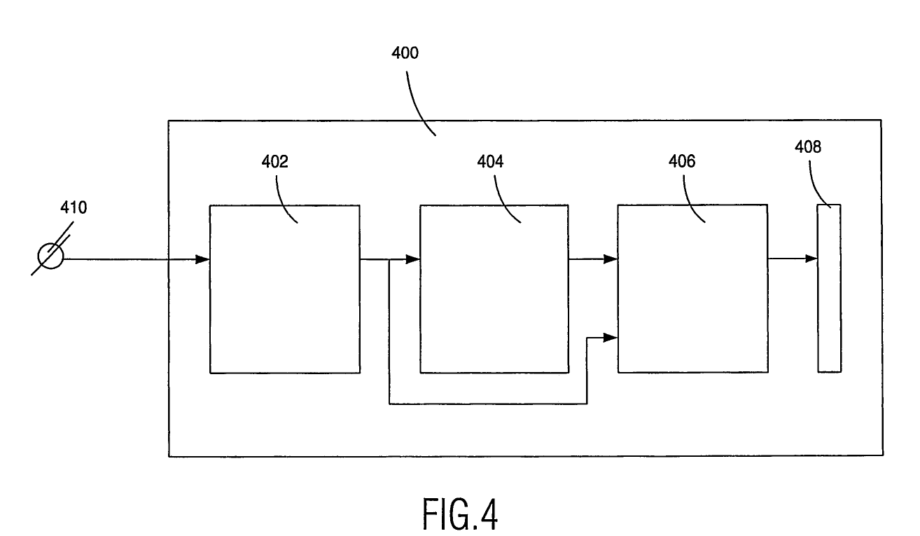

FIG. 4 schematically shows an embodiment of the image processing apparatus. Corresponding reference numerals have the same meaning in all of the Figs.

FIG. 1 schematically shows the concept of the method according to the invention. FIG. 1. shows three successive images 102-106 representing a scene in which a ball moves from right to left in front of a stationary background. The direction of movement is indicated by means of an arrow 110. Based on these three successive images 102-106 two motion vector fields 112 and 114 are estimated. Motion vector field 112 is based on image 104 and image 106. Motion vector field 114 is based on image 104 and image 102. They are calculated by means of a motion estimation unit which is known from the article “True-Motion Estimation with 3-D Recursive Search Block Matching” by G. de Haan et. al. in IEEE Transactions on circuits and systems for video technology, vol.3, no.5, October 1993, pages 368-379. Most of the motion vectors of these two motion vector fields 122 and 114 are equal to zero. They correspond to the non-moving background. These motion vector are called background motion vectors. Other motion vectors of the motion vector fields 112 and 114 correspond to the movement of the ball 108. These latter motion vectors are located in regions 113 and 115, respectively. These motion vectors are called foreground motion vectors. However some of the assigned motion vectors are incorrect: the regions 113 and 115 are to large. This is caused by covering or uncovering: background objects which are visible in an image are not visible in the next image, or background objects which are visible in an image are not visible in the preceding image, respectively. For these cases it is not possible to directly calculate the appropriate motion vectors.

The goal is to calculate motion vector field 124, which matches with the image 104. That means that to pixels corresponding to the ball 108 a foreground motion vector is assigned and to the other pixels a background motion vector is assigned. The former pixels are located in region 126 and the latter pixels are located in region 128. FIG. 1 also comprises an occlusion map 116. The occlusion map 116 is a matrix of elements, with the elements indicating to which of the following types of area the respective pixels of image 104 correspond: covering area 118, uncovering area 122 or no-covering area 120. This occlusion map might be calculated according to the approach described in the patent application which is entitled “Problem area location in an image signal” and published under number WO0011863. It should be noted that it is not necessary that the occlusion map exactly matches with the real occluded parts. However, preferably the covering areas and the uncovering areas of the occlusion map are equal or larger than the really covered and uncovered areas.

The method of estimating motion vectors according to the invention works as follows. Suppose that the motion vector fields 112 and 114 comprise motion vectors of blocks of pixels. Now it is required to determine the appropriate motion vectors for motion vector field 124. For each of the blocks of pixels of motion vector field 124 the following steps are made:
Determine for this block of pixels the type of area by means of the occlusion map 116.
Assign the appropriate motion vector to this block of pixels based on the following test:
If the type of area corresponds to “covering”, then select the motion vector from motion vector field 114. With the motion vector is meant the motion vector belonging to the block of pixels under consideration.
If the type of area corresponds to “uncovering”, then select the motion vector from motion vector field 112. With the motion vector is meant the motion vector belonging to the block of pixels under consideration.
If the type of area corresponds to no-covering, then select the motion vector from motion vector field 112. Note that selection of the motion vector from motion vector field 114 gives the same result.

FIG. 2 schematically shows an embodiment of the motion estimation unit 200 according to the invention. The motion estimation unit 200 comprises:
an intermediate motion estimation unit 202 for estimating a first motion vector field 114 based on image 104 and a preceding image 102 of the image 104 and a second motion vector field 112 based on the image 104 and a succeeding image 106; and
an assignment unit 204 for assigning, based on the type of area of the group of pixels, a final motion vector as the motion vector, with the final motion vector derived from the first motion vector or the second motion vector; and
an occlusion detection unit 206 for calculating an occlusion map 116 based on a motion vector field. The motion vector field is provided by either the intermediate motion estimation unit 202 by means of connection 214 or by the assignment unit 204 via connection 212.
   At the input connector 208 images are provided. The motion estimation unit 200 provides motion vectors at the output connector 210. The working of the motion estimation unit corresponds with method described in connection with FIG. 1.

FIG. 3 schematically shows an embodiment of the motion estimation unit 300 in combination with a re-timer unit 302. The output of the assignment unit 204 can directly be used, e.g. for MPEG compression. In the case of up-conversion it is required to have motion vectors for images to be interpolated. That means images which do not exist in the original series of images which are provided to the motion estimation unit, but which are to be calculated based on the original series of images. The motion estimation unit 300 comprises a re-timer unit 302 which is designed to estimate motion vectors for these new images. A possible approach for re-timing is based on projecting motion vectors of one motion vector field, followed by a scaling of the motion vectors. The scaling depends on time interval differences between original images and new images.

Another approach is based on two successive motion vector fields. In this approach corresponding motion vectors are subtracted from each other. If the difference between these input motion vectors is below a predetermined threshold then the motion vector to be calculated will be based on an average of the two input motion vectors. If the threshold is above a predetermined threshold then a specific one of the two input motion vectors is selected, depending on amongst others the temporal position of the image to be interpolated. The motion vector to be calculated will be based on this input motion vector. The selection might be controlled by means of an occlusion map 116.

FIG. 4 schematically shows elements of an image processing apparatus 400 comprising:
receiving means 402 for receiving a signal representing images to be displayed after some processing has been performed. The signal may be a broadcast signal received via an antenna or cable but may also be a signal from a storage device like a VCR (Video Cassette Recorder) or Digital Versatile Disk (DVD). The signal is provided at the input connector 410.
a motion estimation unit 404 as described in connection with FIG. 2 or FIG. 3;
a motion compensated image processing unit 406; and
a display device 408 or displaying the processed images. This display device 408 is optional.
   The motion compensated image processing unit 406 requires images and motion vectors as its input.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of estimating a motion vector of a group of pixels of an input image (104) comprising:
an occlusion detection step of calculating an occlusion map (116) which is applicable to the input image (104), with the occlusion map (116) indicating to which of the following types of area the group of pixels of the input image (104) corresponds: covering area (118), uncovering area (122) or no-covering area (120);
a first intermediate motion estimation step of estimating a first motion vector for the group of pixels based on the input image (104) and a preceding image (102) of the input image (104);
a second intermediate motion estimation step of estimating a second motion vector for the group of pixels based on the input image (104) and a succeeding image (106) of the input image (104); and
an assignment step of assigning, based on the occlusion map (116), a final motion vector as the motion vector, with the final motion vector derived from the first motion vector or the second motion vector.

2. A method of estimating a motion vector as claimed in claim 1, characterized in that in the assignment step the final motion vector is derived from:
the first motion vector if the type of area of the group of pixels corresponds to covering area (118); and
the second motion vector if the type of area of the group of pixels corresponds to uncovering area (122).

3. A method of estimating a motion vector as claimed in claim 1, characterized in that the occlusion map (116) is calculated on basis of a motion vector field (112, 114).

4. A method of estimating a motion vector as claimed in claim 3, characterized in that the motion vector field (112, 114) is related to the input image (104).

5. A method of estimating a motion vector as claimed in claim 3, characterized in that the motion vector field is related to the preceding image (102).

6. A method of estimating a motion vector as claimed in claim 3, characterized in that the occlusion map (116) is calculated by means of comparing neighboring motion vectors of the motion vector field (112, 114).

7. A motion estimation unit (200, 300) for estimating a motion vector of a group of pixels of an input image (104) comprising:
an occlusion detection unit (206) for calculating an occlusion map (116) which is applicable to the input image (104), with the occlusion map (116) indicating to which of the following types of area the group of pixels of the input image (104) corresponds: covering area (118), uncovering area (122) or no-covering area (120);
an intermediate motion estimation unit (202) for estimating a first motion vector for the group of pixels based on the input image (104) and a preceding image (102) of the input image (104) and a second motion vector for the group of pixels based on the input image (104) and a succeeding image (106) of the input image (104); and
an assignment unit (204) for assigning, based on the occlusion map (116), a final motion vector as the motion vector, with the final motion vector derived from the first motion vector or the second motion vector.

8. An image processing apparatus (400) comprising:
receiving means (402) for receiving a signal representing images (102, 104, 106) to be processed;
motion estimation unit (200, 300) for estimating a motion vector of a group of pixels of an input image (104) of the images comprising:
an occlusion detection unit (206) for calculating an occlusion map (116) which is applicable to the input image (104), with the occlusion map (116) indicating to which of the following types of area the group of pixels of the input image (104) corresponds: covering area (118), uncovering area (122) or no-covering area (120);
an intermediate motion estimation unit (202) for estimating a first motion vector for the group of pixels based on the input image (104) and a preceding image (102) of the input image (104) and a second motion vector for the group of pixels based on the input image (104) and a succeeding image (106) of the input image (104); and
an assignment unit (204) for assigning, based on the occlusion map (116), a final motion vector as the motion vector, with the final motion vector derived from the first motion vector or the second motion vector.
a motion compensated image processing unit.

9. An image processing apparatus (400) as claimed in claim 8, characterized in being designed to perform video compression.

10. An image processing apparatus (400) as claimed in claim 8, characterized in that the motion compensated image processing unit (406) is designed to reduce noise in the images (102, 104, 106).

11. An image processing apparatus (400) as claimed in claim 8, characterized in that the motion compensated image processing unit (406) is designed to de-interlace the images (102, 104, 106).

12. An image processing apparatus (400) as claimed in claim 8, characterized in that the motion compensated image processing unit (406) is designed to perform an up-conversion.
